(19) United States
(12) Patent Application Publication
(10) Pub. No.: US 2025/0274232 A1
(43) Pub. Date: Aug. 28, 2025

(54) Techniques for Estimation of Cyclic Shift in OFDM-based Communication System

(71) Applicant: GCT Semiconductor, Inc., San Jose, CA (US)

(72) Inventors: Sang Il HAN, Seoul (KR); Jeong Min KIM, Seoul (KR); Kyung Jin LEE, Cupertino, CA (US)

(21) Appl. No.: 19/058,650

(22) Filed: Feb. 20, 2025

(30) Foreign Application Priority Data
Feb. 21, 2024 (KR) 10-2024-0024770

(51) Int. Cl. H04L 5/00; H04L 27/26

(52) U.S. Cl. CPC H04L 5/0007; H04L 27/2607; H04L 27/26526

(57) ABSTRACT

Embodiments of a reception signal processing technique in an OFDM-based communication system are disclosed. In one embodiment, a method of operating a receiver in a communication system where at least one OFDM symbol is transmitted, wherein a reference signal group of first to M-th subchannels are transmitted by at least one of the at least one OFDM symbol, and the reference signal group includes a plurality of reference signals to which cyclic shifts corresponding to a respective subchannel are applied, may comprise: generating, based on a received signal, at least one received reference signal group corresponding to a first subchannel; calculating a channel impulse response of the first subchannel based on the at least one received reference signal group corresponding to the first subchannel; and estimating a cyclic shift corresponding to the first subchannel based on the calculated channel impulse response of the first subchannel.

### CROSS REFERENCE TO RELATED APPLICATION

The present application claims priority to Korean Patent Application No. 10-2024-0024770, filed on Feb. 21, 2024, the entire contents of which are incorporated herein for all purposes by this reference.

### BACKGROUND

### Technical Field

This disclosure relates to signal reception processing techniques in communication systems, and more particularly, some embodiments relate to methods for efficiently detecting a Cellular Vehicle-to-Everything (C-V2X) Physical Sidelink Control Channel (PSCCH) through cyclic shift estimation based on Inverse Discrete Fourier Transform (IDFT).

### Description of the Related Art

To implement autonomous vehicles, it is essential to accurately collect information about the vehicle's surroundings and control the vehicle based on this information. Methods for collecting such information include direct sensing technologies, such as cameras, radars, and LiDAR, which are part of Advanced Driver Assistance Systems (ADAS), as well as Vehicle-to-Everything (V2X) communication, which shares the collected information with surrounding vehicles via wireless communication. V2X has become a core technology in this field.

To support V2X communication, international standards have been established, including IEEE 802.11p, known as Dedicated Short Range Communication (DSRC), 3GPP LTE (Long Term Evolution) sidelink, and NR (New Radio) sidelink. Research and implementation related to these standards are actively ongoing.

In the LTE SL and NR SL standards, the entire bandwidth is divided into up to 20 and 27 subchannels, respectively, allowing distinct peer-to-peer communications between vehicles in each subchannel. Each subchannel consists of a Physical Sidelink Control Channel (PSCCH) that includes control information and a Physical Sidelink Shared Channel (PSSCH) that carries a Transport Block (TB). Each user equipment is required to attempt reception for all possible PSCCH candidates and receive only the PSSCH corresponding to the successfully received PSCCH.

Accordingly, efficient signal processing techniques, including methods for effectively detecting PSCCH candidates, may be necessary.

### SUMMARY

Accordingly, efficient signal processing techniques, such as methods for effectively detecting a large number of PSCCH candidates, may be required.

One aspect of this disclosure provides a method of operating a receiver in a communication system where at least one OFDM symbol is transmitted, wherein a reference signal group of first to M-th subchannels (where M is a natural number greater than or equal to 2) are transmitted by at least one of the at least one OFDM symbol, and the reference signal group includes a plurality of reference signals to which cyclic shifts corresponding to a respective subchannel are applied. In some embodiments, the method may comprise: generating, based on a received signal, at least one received reference signal group corresponding to the first subchannel, wherein each of the at least one received reference signal group includes received reference signals received through the corresponding OFDM symbol and the first subchannel; calculating a channel impulse response of the first subchannel based on the at least one received reference signal group corresponding to the first subchannel; and estimating a cyclic shift corresponding to the first subchannel based on the calculated channel impulse response of the first subchannel.

In some embodiments, the generating the at least one received reference signal group may comprise: extracting at least one sample group corresponding to a symbol body of each of the at least one OFDM symbol from the received signal; generating at least one frequency domain signal by applying Discrete Fourier Transform (DFT) to each of the extracted at least one sample group; and extracting the received reference signals included in each of the at least one received reference signal group corresponding to the first subchannel from the generated at least one frequency domain signal.

In some embodiments, the calculating the channel impulse response may comprise: generating a time domain signal corresponding to each of the at least one received reference signal group; and calculating the channel impulse response based on the generated at least one time domain signal.

In some embodiments, the generating the at least one time domain signal may comprise: generating at least one descrambling result symbol group by applying descrambling to each of the at least one received reference signal group; and generating the at least one time domain signal by applying Inverse Discrete Fourier Transform (IDFT) to each of the generated at least one descrambling result symbol group. In some embodiments, the size of the IDFT may be four times the size of the descrambling result symbol group that is the target of IDFT. In some embodiments, the size of the IDFT may be greater than or equal to the size of the descrambling result symbol group that is the target of IDFT, and the applying the IDFT may comprises applying the IDFT by positioning the center of the descrambling result symbol group that is the target of IDFT at the center of the IDFT window.

In some embodiments, the reference signal group of the first subchannel may be transmitted through one OFDM symbol, the generating the at least one received reference signal group may comprise generating one received reference signal group corresponding to the first subchannel, the generating the at least one time domain signal may comprise generating a time domain signal corresponding to the generated one received reference signal group, and the calculating the channel impulse response may comprise determining the generated one time domain signal as the channel impulse response.

In some embodiments, the reference signal group of the first subchannel may be transmitted through a plurality of OFDM symbols, the generating the at least one received reference signal group may comprise generating a plurality of received reference signal groups corresponding to the first subchannel, the generating the at least one time domain signal may comprise generating a time domain signal corresponding to each of the plurality of received reference signal groups, and the calculating the channel impulse response may comprise calculating the channel impulse response by summing time domain samples included in each of the generated time domain signals by the same time index.

In some embodiments, the estimating the cyclic shift may comprise: detecting a time index having a maximum value among time domain samples of the channel impulse response; and estimating the cyclic shift corresponding to each of the at least one subchannel based on the detected time index. In some embodiments, the estimating the cyclic shift may comprise estimating the cyclic shift based on an interval to which the time index having the maximum value of the channel impulse response belongs among a plurality of intervals, and the plurality of intervals may be intervals obtained by dividing a time domain interval of the channel impulse response based on statistical characteristics of the channel impulse response when cyclic shifts corresponding to each of the M subchannels are given. In some embodiments, the statistical characteristics of the channel impulse response may form a sinc function centered on each of the plurality of intervals.

In some embodiments, the method may further comprise: estimating a timing offset based on the estimated channel impulse response. In some embodiments, the estimating the cyclic shift may comprise estimating the cyclic shift corresponding to each of the at least one subchannel based on the time index having the maximum value among time domain samples of the channel impulse response, and the estimating the timing offset may comprise estimating the timing offset based on: a ratio between the size of DFT used in generating the at least one received reference signal group and the size of IDFT used in calculating the channel impulse response; the time index having the maximum value; and the estimated cyclic shift.

In some embodiments, the method may further comprise for each m (where m has a value between 2 and M): generating, based on the received signal, at least one received reference signal group corresponding to the m-th subchannel, wherein each of at least one received reference signal group corresponding to the m-th subchannel includes received reference signals received through the corresponding OFDM symbol and the m-th subchannel; calculating a channel impulse response of the m-th subchannel based on the at least one received reference signal group corresponding to the m-th subchannel; and estimating a cyclic shift corresponding to the m-th subchannel based on the calculated channel impulse response of the m-th subchannel.

In some embodiments, each of the first to M-th subchannels may include PSCCH and PSSCH of LTE sidelink, and the reference signal group of each of the first to M-th subchannels may include a reference signal group of the PSCCH included in the corresponding subchannel.

In some embodiments, each of the first to M-th subchannels may include PSCCH and PSSCH of NR sidelink, and the reference signal group of each of the first to Mth subchannels may include a reference signal group of the PSCCH included in the corresponding subchannel.

Another aspect of this disclosure provides a receiving apparatus in a communication system where at least one OFDM symbol is transmitted, wherein a reference signal group of first to M-th subchannels (where M is a natural number greater than or equal to 2) are transmitted by at least one of the at least one OFDM symbol, and the reference signal group includes a plurality of reference signals to which cyclic shifts corresponding to a respective subchannel are applied. In some embodiments, the apparatus may comprise: a received reference signal group generation block configured to generate, based on a received signal, at least one received reference signal group corresponding to the first subchannel, wherein each of the at least one received reference signal group includes received reference signals received through the corresponding OFDM symbol and the first subchannel; a channel impulse response calculation block configured to calculate a channel impulse response of the first subchannel based on the at least one received reference signal group corresponding to the first subchannel; and a cyclic shift estimation block configured to estimate a cyclic shift corresponding to the first subchannel based on the calculated channel impulse response of the first subchannel.

In some embodiments, the received reference signal group generation block may comprise: a sample group extraction block configured to extract at least one sample group corresponding to a symbol body of each of the at least one OFDM symbol from the received signal; a DFT block configured to generate at least one frequency domain signal by applying DFT to each of the extracted at least one sample group; and a received reference signal extraction block configured to extract the received reference signals included in each of the at least one received reference signal group corresponding to the first subchannel from the generated at least one frequency domain signal.

In some embodiments, the channel impulse response calculation block may comprise: a time domain signal generation block configured to generate a time domain signal corresponding to each of the at least one received reference signal group; and a calculation block configured to calculate the channel impulse response based on the generated at least one time domain signal.

In some embodiments, the time domain signal generation block may comprise: a descrambling block configured to generate at least one descrambling result symbol group by applying descrambling to each of the at least one received reference signal group; and an IDFT block configured to generate the at least one time domain signal by applying IDFT to each of the generated at least one descrambling result symbol group.

In some embodiments, the cyclic shift estimation block may comprise: a detection block configured to detect a time index having a maximum value among time domain samples of the channel impulse response; and an estimation block configured to estimate the cyclic shift corresponding to each of the at least one subchannel based on the detected time index.

In some embodiments, the apparatus may further comprise: a timing offset estimation block configured to estimate a timing offset based on the estimated channel impulse response.

In some embodiments, for each m (where m has a value between 2 and M): the received reference signal group generation block may generate, based on the received signal, at least one received reference signal group corresponding to the m-th subchannel, wherein each of at least one received reference signal group corresponding to the m-th subchannel includes received reference signals received through the corresponding OFDM symbol and the m-th subchannel; the channel impulse response calculation block may calculate a channel impulse response of the m-th subchannel based on the at least one received reference signal group corresponding to the m-th subchannel; and the cyclic shift estimation block may estimate a cyclic shift corresponding to the m-th subchannel based on the calculated channel impulse response of the m-th subchannel.

In some embodiments, each of the first to M-th subchannels may be include PSCCH and PSSCH of LTE sidelink, and the reference signal group of each of the first to M-th subchannels may include a reference signal group of the PSCCH included in the corresponding subchannel.

In some embodiments, each of the first to M-th subchannels may include PSCCH and PSSCH of NR sidelink, and the reference signal group of each of the first to Mth subchannels may include a reference signal group of the PSCCH included in the corresponding subchannel.

Yet another aspect of this disclosure provides a non-transitory recording medium storing instructions readable by a processor of an electronic device, wherein the instructions cause the processor to perform embodiments of this disclosure.

This summary is provided to introduce a selection of concepts in a simplified form that are further described in the detailed description below. This summary is not intended to identify key or essential features of the claimed subject matter, nor is it intended to be used to limit the scope of the claimed subject matter. The claimed subject matter is not limited to implementations that solve any or all disadvantages noted in any part of this disclosure. In addition to the exemplary aspects, embodiments, and features described above, further aspects, embodiments, and features will become apparent from the following detailed description and accompanying drawings.

Some embodiments of this disclosure may have an effect including the following advantages. However, since it is not meant that all exemplary embodiments should include all of them, the scope of the present disclosure should not be understood as being limited thereto.

According to some embodiments, cyclic shift and timing offset can be simultaneously calculated using an IDFT applied to the PSCCH DMRS.

According to some embodiments, a cyclic shift estimation technique with excellent performance can be provided, even in environments with large timing offsets.

According to some embodiments, a cyclic shift estimation technique in which additional logic is minimized by recycling existing logic (e.g., logic for obtaining a timing offset) can be provided.

According to some embodiments, the number of reception attempts for multiple PSCCH candidates can be effectively reduced by using excellent cyclic shift detection performance.

### BRIEF DESCRIPTION OF THE DRAWINGS

FIG. 1 illustrates an example of an OFDM symbol generation block.

FIG. 2 illustrates an example of an OFDM symbol.

FIG. 3 illustrates an example of a 3GPP LTE frame structure.

FIGS. 4A and 4B illustrate examples of resource grids for LTE sidelink (SL).

FIG. 5 illustrates an example of a resource grid for NR SL.

FIGS. 6 and 7 illustrate examples of subframe structures for LTE SL and NR SL, respectively.

FIG. 8 is a diagram explaining DMRS REs included in the PSCCH of NR SL.

FIG. 9 is a block diagram illustrating several embodiments of signal processing for reception.

FIG. 10 is pseudocode explaining some embodiments for estimating cyclic shifts applied to PSCCH DMRS from IDFT results.

FIG. 11 illustrates an example of channel impulse response (CIR) in LTE SL when there is no timing offset.

FIG. 12 illustrates an example of CIR in LTE SL when there is a timing offset.

FIG. 13 illustrates an example of CIR in NR SL when there is no timing offset.

FIG. 14 illustrates an example of CIR in NR SL when there is a timing offset.

FIG. 15 illustrates a graph showing the performance of the cyclic shift estimation technique disclosed herein for LTE SL.

FIG. 16 shows Table 14.2-1 from the 3GPP standard document (3GPP 36.101), specifying performance requirements related to timing offset and frequency offset in LTE SL.

FIG. 17 shows Table 14.2-2 from the 3GPP standard document (3GPP 36.101), specifying performance requirements in LTE SL.

FIG. 18 illustrates a graph showing the performance of the cyclic shift estimation technique disclosed herein for NR SL.

FIG. 19 illustrates performance requirements for NR SL.

### DETAILED DESCRIPTION OF THE DISCLOSURE

Since the description of the present disclosure is merely an exemplary embodiment for structural or functional description, the scope of the present disclosure should not be construed as being limited by the exemplary embodiments described in the text. That is, since exemplary embodiments may be changed in various ways and may have various forms, it should be understood that the right scope of the present disclosure includes equivalents that can realize the technical idea. In addition, the objectives or effects presented in the present disclosure may not mean that a specific exemplary embodiment should include all or only such effects, so the right scope of the present disclosure should not be understood as being limited thereto.

Meanwhile, the meaning of the terms described in the present disclosure should be understood as follows.

Terms such as “first”, “second”, and the like are intended to distinguish one component from another component, and the scope of rights should not be limited by these terms. For example, a first component may be referred to as a second component, and similarly, a second component may also be referred to as a first component.

When a component is referred to as being “connected” to another component, it may be directly connected to the other component, but it should be understood that other components may exist in the middle. On the other hand, when a component is referred to as being “directly connected” to another component, it should be understood that no other component exists in the middle. Meanwhile, other expressions describing the relationship between components, such as “between” and “immediately between” or “neighboring to” and “directly neighboring to”, should be interpreted in the same way.

Singular expressions should be understood to include plural expressions unless the context clearly indicates otherwise, and terms such as “include” or “have” are intended to designate the existence of features, numbers, steps, actions, components, parts, or combinations thereof, and should be understood not to preclude the possibilities of the existence or addition of one or more other features or numbers, steps, actions, components, parts, or combinations thereof.

In each step, identification codes (e.g., a, b, c, etc.) may be used for the convenience of explanation, and identification codes may not describe the order of each step, and each step may occur differently from the specified order unless a specific order is explicitly stated in the context. That is, each step may occur in the same order as the specified order, may be performed substantially simultaneously, or may be performed in the opposite order.

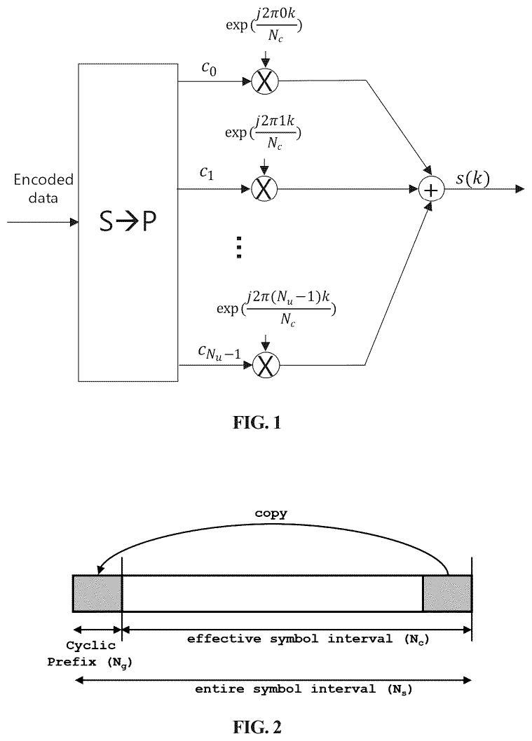

FIG. 1 illustrates an example of an OFDM symbol generation block.

Orthogonal Frequency Division Multiplexing (OFDM) is a transmission method that divides the data to be transmitted into multiple smaller data units, modulates them into mutually orthogonal subcarriers using an inverse fast Fourier transform (IFFT), and transmits them simultaneously, as illustrated in FIG. 1.

FIG. 2 illustrates an example of an OFDM symbol.

As illustrated in FIG. 2, an OFDM symbol may include a cyclic prefix (CP) and a symbol body, which is the main part of the transmission signal. The CP, formed by appending a portion of the end of the multi-carrier transmission signal (i.e., the region corresponding to the cyclic prefix within the symbol body, hereinafter referred to as the “cyclic prefix corresponding region”) to the front, can mitigate multipath interference. In 3GPP LTE/NR, when the symbol body duration N_{c} is 2048Tₛ based on the basic time unit Tₛ, the CP duration is specified as N_{g}=144Tₛ or 160Tₛ for normal CP and N_{g}=512Tₛ for extended CP.

The combination of a CP and a symbol body is referred to as CP-OFDM. In the 3GPP LTE/NR sidelink, CP-OFDM is employed.

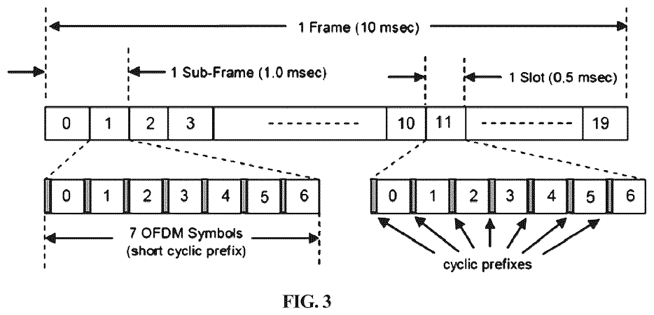

FIG. 3 illustrates an example of the 3GPP LTE frame structure.

As shown in FIG. 3, in 3GPP LTE/NR, a frame can be composed, along the time axis, of time units (e.g., subframes or slots) consisting of multiple OFDM symbols. Along the frequency axis, it can be composed of resource blocks (RBs) consisting of multiple (e.g., 12) subcarriers.

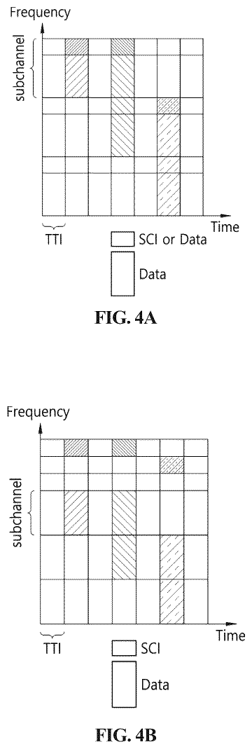

FIGS. 4A and 4B illustrate examples of the resource grid for LTE sidelink (SL).

In LTE sidelink (SL), as illustrated in FIGS. 4A and 4B, peer-to-peer communication may be performed using a pair of channels: a Physical Sidelink Control Channel (PSCCH) that carries sidelink control information (SCI) composed of two resource blocks (RBs) and a Physical Sidelink Shared Channel (PSSCH) that carries data information composed of N_{PSSCH}^{RB} RBs. The PSSCH may be configured with varying sizes by allocating one or more subchannels. According to higher layer control signaling (RRC message), the PSCCH and PSSCH may be configured either adjacently as shown in FIG. 4A, or non-adjacently as shown in FIG. 4B. In one example, with reference to FIG. 4A, among the shaded blocks, the uppermost block corresponds to the PSCCH, while the remaining blocks correspond to the PSSCH. In another example, with reference to FIG. 4B, the uppermost shaded block corresponds to the PSCCH, while the shaded block separated from but positioned below the uppermost shaded block (i.e., in a different frequency region within the same OFDM symbol) corresponds to the PSSCH.

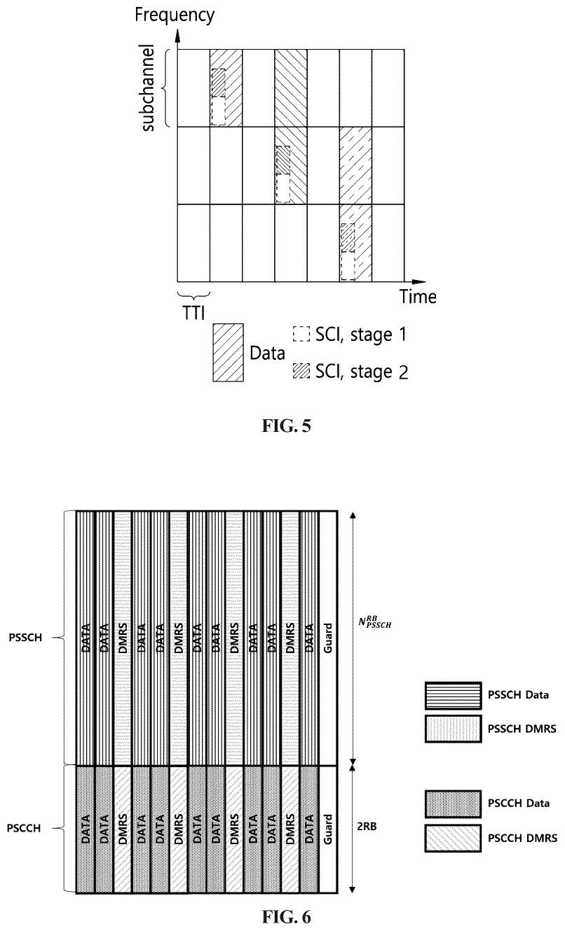

FIG. 5 illustrates an example of a resource grid of NR SL.

In NR SL, as illustrated in FIG. 5, PSCCH and PSSCH may each be allocated to one or more subchannels. However, unlike LTE, it comprises a two-stage SCI, wherein the PSCCH and PSSCH are configured adjacently. In one example, with reference to FIG. 5, the white box with dotted lines represents the first-stage SCI included in the PSCCH, the shaded box with dotted lines represents the second-stage SCI included in the PSSCH, and the solid-line box encompassing both the white and shaded dotted-line boxes may contain PSSCH data in the remaining resource elements excluding the aforementioned dotted-line boxes.

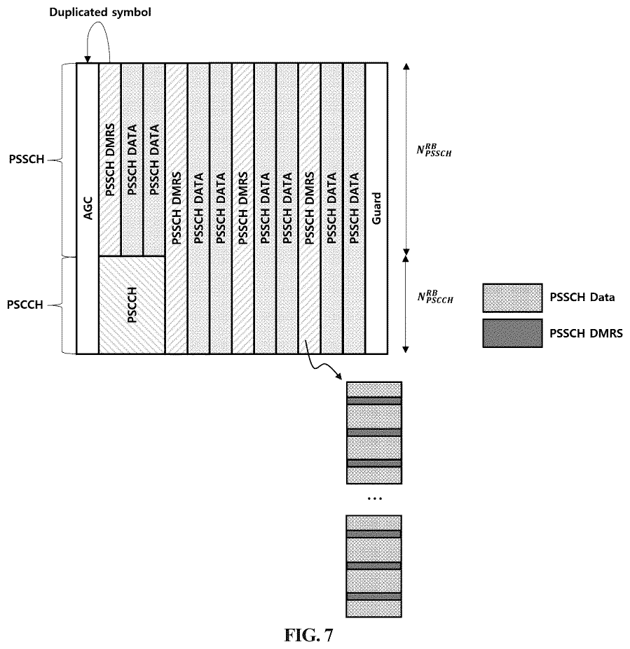

FIGS. 6 and 7 illustrate examples of subframe structures for LTE SL and NR SL, respectively.

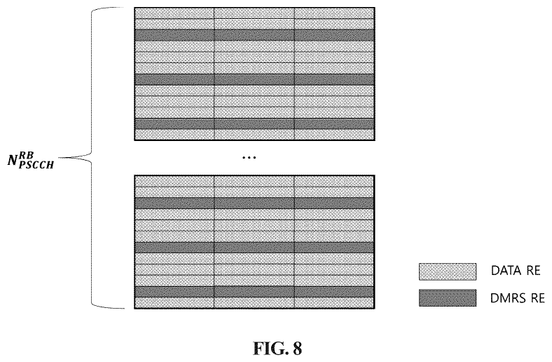

FIG. 8 is a diagram explaining DMRS REs included in the PSCCH of NR SL.

In LTE SL, as illustrated in FIG. 6, one subframe may comprise OFDM symbols including four demodulation reference signal (DMRS) symbols and data symbols. With reference to FIG. 6, it can be observed that the OFDM symbols corresponding to DMRS symbols comprise PSSCH DMRS and PSCCH DMRS in the frequency domain. Furthermore, with reference to FIG. 6, it can be observed that the OFDM symbols corresponding to data symbols comprise PSCCH data signals and PSSCH data signals in the frequency domain.

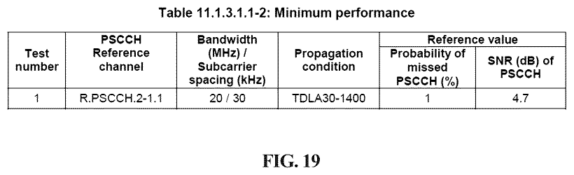

In NR SL, the number of DMRS symbols may be variably modified through higher layer control signaling. With reference to FIG. 7, the second through fourth OFDM symbols include PSCCH, wherein said PSCCH may include PSCCH data signals and PSCCH DMRS in the corresponding frequency domain, as illustrated in FIG. 19. With reference to FIG. 7, the OFDM symbols designated as PSSCH DMRS may include PSSCH DMRS and PSSCH data signals in the frequency domain.

Common to both LTE SL and NR SL, the last symbol of the subframe is specified as a guard period, during which no signals are transmitted.

In LTE sidelink and NR sidelink, as illustrated in FIGS. 4 and 5, the entire bandwidth may be divided into a plurality of subchannels (e.g., M=N_{sub} subchannels), and vehicle-to-everything (V2X) communication may be performed through one or more of the subchannels. In this disclosure, M and N_{sub} are symbols representing the number of subchannels, and for convenience, they are used interchangeably (e.g., M is used in descriptive expressions, and N_{sub} is used in expressions related to mathematical formulas).

Each subchannel may comprise a PSCCH with control information and a PSSCH with a transport block (TB), as illustrated in FIGS. 4 through 8.

A demodulation reference signal (DMRS) used for PSCCH channel estimation is a predetermined signal having a constant amplitude in the frequency domain, although the phase may vary. DMRS is specified differently in LTE sidelink and NR sidelink as follows.

As illustrated in FIG. 6, an LTE sidelink DMRS exists on four OFDM symbols and two resource blocks (RBs), and all resource elements (REs) in the corresponding RB are DMRS. An LTE sidelink DMRS may be transmitted by multiplying a basic reference signal d(k) by a linear phase according to a cyclic shift n_{cs}, as shown in Equation 1. The cyclic shift n_{cs} may have a value of 0, 3, 6, or 9, and may be arbitrarily selected by a transmitting user equipment (UE).

$$s ( k ) = d ( k ) * exp ( \frac{j 2 π {n}_{cs} k}{12} ) , k = 0 , .. , 23 \qquad [ Equation 1 ]$$

As illustrated in FIGS. 7 and 8, an NR sidelink DMRS exists on two or three OFDM symbols and N_{PSCCH}^{RB} resource blocks (RBs), and within the corresponding RB, only one RE out of four REs is a DMRS. An NR sidelink DMRS may be transmitted by multiplying a basic reference signal d(k) by a linear phase w_{f,i} defined by Equation 3, as shown in Equation 2. In Equation 3, i may be arbitrarily selected by a transmitting UE from among 0, 1, and 2. Similar to the LTE sidelink DMRS, since a linear phase is multiplied by the basic reference signal, the NR sidelink DMRS can also be considered a signal to which a cyclic shift is applied.

$$s ( k ) = s ( 12 n + 4 {k}^{′} + 1 ) = d ( 3 n + {k}^{′} ) * {w}_{f , i} ( {k}^{′} ) , \\ n = 0 , … , {N}_{PSCCH}^{RB} - 1 , {k}^{′} = 0 , 1 , 2 \qquad [ Equation 2 ]$$

$${w}_{f , i} ( {k}^{′} ) = exp ( \frac{j 2 π {ik}^{′}}{3} ) \qquad [ Equation 3 ]$$

Since the receiving UE does not know in advance which cyclic shift the transmitting UE uses for transmission, it must attempt reception for each cyclic shift candidate for each PSCCH. Accordingly, in LTE SL, there may be 4N_{sub} PSCCH candidates, and in NR SL, there may be 3N_{sub} PSCCH candidates.

Some embodiments of the present disclosure relate to techniques for reducing the number of reception attempts by enabling the receiving UE to estimate the cyclic shift prior to receiving the PSCCH.

When the discrete Fourier transform (DFT) result of a time domain signal x[n] in CP-OFDM is X[k], the DFT result of x[((n−τ)_{N}] with a timing offset τ may be expressed

$$exp ( \frac{- j 2 π n τ}{N} ) X [ k ] .$$

That is, similar to the cyclic shift applied to the PSCCH DMRS in LTE/NR SL, the timing offset may generate a linear phase proportional to the subcarrier index k in the frequency domain.

As described above, the receiving UE in V2X SL must attempt reception for a large number of PSCCH candidates. Meanwhile, V2X communication requires low processing latency for urgent data transmissions, such as collision avoidance between vehicles. Therefore, techniques for reducing the number of reception attempts among the large number of PSCCH candidates may be required to meet the low processing latency requirements. Some embodiments of the present disclosure relate to techniques for reducing the number of reception attempts among the large number of PSCCH candidates to meet the low processing latency requirements.

Meanwhile, in V2X communication, direct peer-to-peer communication between vehicles may lead to synchronization errors (or timing offsets) and frequency errors (or frequency offsets) due to imperfections in the local oscillator of the vehicle's transceiver. Each peer-to-peer communication may require compensation for such errors. The 3GPP standards (3GPP 36.101 and 38.101) specify performance requirements that accommodate a timing offset between vehicles up to T_{g}/2−12Tₛ. In environments with large timing offsets, techniques for effectively estimating the cyclic shift applied to DMRS may be required to reduce the number of PSCCH candidates for reception attempts. Several embodiments of the present disclosure relate to techniques for effectively estimating cyclic shifts in environments with large timing offsets.

Previous studies on reducing PSCCH reception attempts include Blind Decoding (BD) and Sensing-Based Algorithm (SALG) techniques.

The BD technique measures the Reference Signals Received Power (RSRP) for each cyclic shift and prioritizes reception attempts based on the cyclic shifts with higher RSRP values. If the processed signal for the prioritized cyclic shift passes subsequent checks (e.g., Cyclic Redundancy Check (CRC)), reception attempts for lower-priority cyclic shifts (e.g., those with lower RSRP) can be skipped, thereby reducing the total number of reception attempts.

The SALG technique calculates correlation between the phases associated with each cyclic shift and the received DMRS. Reception attempts for the PSCCH are based on signals processed using cyclic shifts with high correlation values.

However, both techniques depend on correlation between the linear phase corresponding to cyclic shifts and DMRS, which may result in erroneous cyclic shift estimation in cases of large timing offsets, as the correlation values decrease.

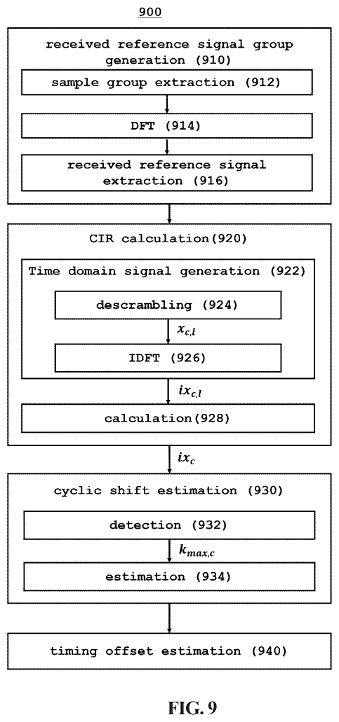

FIG. 9 is a block diagram illustrating several embodiments of signal processing for reception.

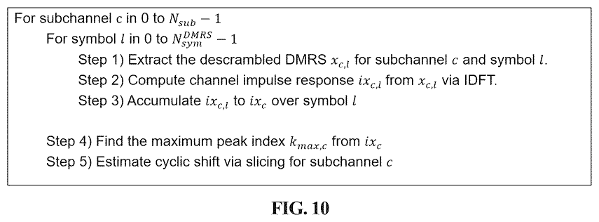

FIG. 10 is pseudocode explaining some embodiments for estimating cyclic shifts applied to PSCCH DMRS from IDFT results. For example, some embodiments in FIG. 10 include five steps for estimating the cyclic shift applied to the PSCCH DMRS based on IDFT results used for timing offset estimation.

In some embodiments, as illustrated in FIG. 9, a receiving device (900) may comprise at least some of the following blocks: a received reference signal group generation block (910), a CIR calculation block (920), a cyclic shift estimation block (930), and a timing offset estimation block (940).

In some embodiments, the receiving device (900) may further include blocks not shown in FIG. 9 (e.g., receiving antenna, RF circuitry, and channel decoder). For example, the receiving device (900) may further include a module for performing a reception attempt (e.g., CRC test) for the PSCCH based on estimation information obtained through the cyclic shift estimation block (930) and/or the timing offset estimation block (940).

In some embodiments, the receiving device (900) may correspond to a receiver in an OFDM symbol-based communication system. For example, the receiving device (900) may correspond to a receiving UE in V2X communication.

In some embodiments, the OFDM symbol-based communication system may transmit at least one OFDM symbol over a wireless channel, which may be received by the receiver via the wireless channel. In some embodiments, a reference signal group for each of the first to M-th (where M is a natural number greater than or equal to 2) subchannels may be transmitted using the at least one OFDM symbol. In some embodiments, the reference signal group may include a plurality of reference signals to which cyclic shifts corresponding to a respective subchannel are applied.

In some embodiments, the plurality of subchannels may include a plurality of PSCCHs in LTE sidelink communication, and the reference signals may include demodulation reference signals for each PSCCH.

In some embodiments, the plurality of subchannels may include a plurality of PSCCHs for NR sidelink, and the reference signals may include demodulation reference signals for each PSCCH.

In some embodiments, the aforementioned first to M-th subchannels may correspond to subchannels corresponding to subchannel indices c=0 to N_{sub-}1 in FIG. 10.

In some embodiments, the at least one OFDM symbol may correspond to a plurality of OFDM symbols. For example, the plurality of OFDM symbols may correspond to OFDM symbols having symbol indices 1=0 to N_{sym}^{DMRS}−1 as shown in FIG. 10. In this case, as described below, a summation operation (e.g., Step 3 in FIG. 10) may be performed on signals corresponding to the plurality of OFDM symbols (e.g., ix_{c,l} in FIG. 10).

In other embodiments, the at least one OFDM symbol may correspond to a single OFDM symbol. For example, at least one of the aforementioned first to M-th subchannels may transmit demodulation reference signals for the corresponding subchannel through a single OFDM symbol, or the receiver may process received signals for some embodiments of this disclosure using only one of the at least one OFDM symbols. In this case, as described below, cyclic shift estimation may be performed based on the signal corresponding to a single OFDM symbol without performing a summation operation (e.g., Step 3 in FIG. 10).

Some of the following descriptions mainly disclose some embodiments focused on processing for the first subchannel; however, such embodiments may likewise apply to processes for other subchannels (e.g., the second to M-th subchannels). For example, as illustrated in FIG. 10, such operations may be repeated while the subchannel index c ranges from 0 to N_{sub}−1.

In some embodiments, a receive reference signal group generation block (910) may generate at least one received reference signal group corresponding to the first subchannel based on received signals.

In some embodiments, a received reference signal group generation block (910) may generate, based on a received signal, at least one received reference signal group corresponding to the first subchannel. In some embodiments, each of the at least one received reference signal group may include received reference signals received through the corresponding OFDM symbol and the first subchannel

In some embodiments, a CIR calculation block (920) may calculate a channel impulse response (CIR) of the first subchannel based on the at least one received reference signal group generated by the received reference signal group generation block (910).

In some embodiments, a cyclic shift estimation block (930) may estimate a cyclic shift corresponding to the first subchannel based on the CIR of the first subchannel calculated by the CIR calculation block (920).

In some embodiments, as illustrated in FIG. 9, the received reference signal group generation block (910) may include a sample group extraction block (912), a DFT block (914), and a received reference signal extraction block (916).

In some embodiments, the sample group extraction block (912) may extract at least one sample group corresponding to the symbol body of each of at least one OFDM symbol from the received signal.

In some embodiments, the DFT block (914) may apply DFT to each of the at least one sample group extracted by the sample group extraction block (912) to generate at least one frequency domain signal.

Each frequency domain signal, as a result of the DFT, may include received demodulation reference symbols r(k) expressed by Equation 4. Equation 4 may be derived from Equations 1 and 2 and the linear phase caused by timing offset.

$$r ( k ) = H \cdot s ( k ) = H \cdot d ( k ) exp ( j 2 πε k / N ) exp ( - j 2 πτ k / N ) = H \cdot d ( k ) exp ( j 2 π ( ε - τ ) k / N ) \qquad [ Equation 4 ]$$

In Equation 4, H denotes the channel response. For simplicity, the channel response is assumed to be a one-tap response. However, some embodiments of the present disclosure may likewise apply the same principles to channel responses that are not one-tap responses.

In Equation (4), ε represents a cyclic shift scaled with respect to the IFFT size N, and τ represents a timing offset scaled with respect to the IFFT size N.

In some embodiments, the received reference signal extraction block (916) may extract received reference signals included in each of the at least one received reference signal groups corresponding to the first subchannel from the at least one frequency domain signal generated by the DFT block (914).

In some embodiments, as illustrated in FIG. 9, the CIR calculation block (920) may comprise a time domain signal generation block (922) and a calculation block (928).

In some embodiments, the time domain signal generation block (922) may generate a time domain signal corresponding to each of at least one receive reference signal group associated with the first subchannel, which is generated by the received reference signal group generation block (910).

In some embodiments, the calculation block (928) may calculate the CIR of the first subchannel based on the at least one time domain signal generated by the time domain signal generation block (922).

In some embodiments, as illustrated in FIG. 9, the time domain signal generation block (922) may comprise a descrambling block (924) and an IDFT block (926).

In some embodiments, the descrambling block (924) may apply descrambling to each of at least one received reference signal group associated with the first subchannel, generated by the received reference signal group generation block (910), to generate at least one descrambling result symbol group.

As described above, DMRS signals are a pre-known signal with fixed magnitudes but variable phases. Therefore, the receiver may compensate for the phase of the DMRS to transform it into a signal with fixed magnitude and phase for channel estimation. Similarly, the descrambling block (924) may generate descrambled signals x_{c,l} by multiplying each received reference signal by the complex conjugate of the corresponding base reference signal d(k), as shown in Step 1 of FIG. 10.

For example, in LTE SL, when the number of resource elements (REs) in the PSCCH corresponding to subchannel index c is N_{PSCCH}^{RE}, the descrambling block (924) may generate descrambling result symbol groups as expressed in Equation 5. The descrambling result symbol group may include N_{PSCCH}^{RE} descrambled signals x_{c,l}(k) corresponding to the received reference signal group of the subchannel (subchannel index c) contained in the corresponding OFDM symbol (symbol index 1).

$${x}_{c , l} ( k ) = r ( k ) \cdot \frac{{d ( k )}^{*}}{{\vert d ( k ) \vert}^{2}} = H \cdot exp ( \frac{j 2 π ( ε - τ ) k}{N} ) d ( k ) \cdot \frac{{d ( k )}^{*}}{{\vert d ( k ) \vert}^{2}} = H \cdot exp ( \frac{j 2 π ( ε - τ ) k}{N} ) , k = 0 , .. , {N}_{PSCCH}^{RE} - 1 \qquad [ Equation 5 ]$$

In another example, since there is one DMRS RE for every four REs in NR SL, the descrambling block (924) may generate descrambling result symbol groups expressed by Equation 6. The descrambling result symbol group may include descrambled signals x_{c,l}(k) corresponding to the received reference signal group of the subchannel (subchannel index c) contained in the corresponding OFDM symbol (symbol index 1).

$${x}_{c , l} ( k ) = H \cdot exp ( \frac{j 2 π ( ε - τ ) k}{N} ) , k = 1 , 5 , 9 , .. , 4 {N}_{PSCCH}^{RE} - 3 \qquad [ Equation 6 ]$$

In some embodiments, the IDFT block (926) may apply an IDFT to each of at least one descrambling result symbol group generated by the descrambling block (924) to generate at least one time domain signal. In some embodiments, the size of the IDFT may be equal to or greater than the size of the descrambling result symbol group being processed. The IDFT block (926) may align the center of the descrambling result symbol group with the center of the IDFT window and then apply the IDFT.

In some embodiments, the size of the IDFT may be four times the size of the descrambling result symbol group being processed.

The operation of the IDFT block (926) in some embodiments may correspond to Step 2 in FIG. 10. Generally, while timing offset is corrected in the channel estimation process, linear phase may still exist after correction due to timing offset estimation error. In some embodiments, an IDFT size of four times the number of PSCCH DMRS REs may be selected such that the linear phase between the end points of DMRS RE due to estimation error is π/4 or less. For example, in LTE SL, since all REs in each DMRS symbol are DMRS REs, an IDFT size of 4N_{PSCCH}^{RE} may be selected to calculate the CIR. In another example, in NR SL, since only one out of every four REs is a DMRS RE, an IDFT size of N_{PSCCH}^{RE} may be selected to calculate the CIR.

The IDFT size may be adjusted as needed, and is denoted as N′ hereafter.

For example, in LTE SL, when the center of the PSCCH DMRS RE is aligned with the center of the IDFT, and an IDFT of size N′ is performed, the CIR ix_{c,l}(n) can be obtained as expressed in Equation 7.

$$[ Equation 7 ]$$

$$\begin{matrix}i {x}_{c , l} ( n ) = \frac{1}{{N}^{′}} \frac{{n}_{PSCCH}^{RE}}{{\sum }_{k = - ( \frac{{N}_{PSCCH}^{RE}}{2} ) + 1}^{2}} H \cdot exp ( \frac{j 2 π ( ε - τ ) k}{N} ) exp ( \frac{j 2 π kn}{{N}^{′}} ) \\ = \frac{H}{{N}^{′}} \frac{{N}_{PSCCH}^{RE}}{{\sum }_{k = - ( \frac{{N}_{PSCCH}^{RE}}{2} ) + 1}^{2}} exp ( \frac{j 2 π k ( n + \frac{{N}^{′}}{N} ( ε - τ ) )}{{N}^{′}} ) \\ = \frac{H}{{N}^{′}} \cdot \frac{sin ( π ( n + \frac{{N}^{′}}{N} ( ε - τ ) ) {N}_{PSCCH}^{RE} / {N}^{′}}{sin ( π ( n + \frac{{N}^{′}}{N} ( ε - τ ) ) / {N}^{′} )}\end{matrix}$$

Referring to Equation 7, the CIR ix_{c,l}(n) can be considered as a sinc function circularly shifted by

$$- \frac{{N}^{′}}{N} ( ε - τ )$$

on the CIR. For another example, in NR SL, since IDFT is applied by extracting only one DMRS RE per 4 REs, the CIR ix_{c,l}(n) can be considered as a sinc function circularly shifted by

$$- \frac{4 {N}^{′}}{N} ( ε - τ )$$

### in the CIR.

As described above, the calculation block (928) may calculate the channel impulse response (CIR) of the first subchannel based on at least one time domain signal generated by the time domain signal generation block (922).

In some embodiments, if only one time domain signal (e.g., ix_{c,l} for l=0) is generated or used, the calculation block (928) may determine the corresponding time domain signal as the CIR.

In other embodiments, if multiple time domain signals (e.g., ix_{c,l,} l=0, 1, . . . , N_{sym}^{DMRS}−1) are generated and used, the calculation block (928) may determine the summed result as the CIR by summing the corresponding time domain signals, as shown in Step 3 of FIG. 10.

For example, the calculation block (928) may calculate the CIR by summing time domain samples with the same time indices across the multiple time domain signals. That is, certain embodiments of the calculation block (928) may correspond to Step 3 in FIG. 10. For instance, the calculation block (928) may accumulate the PSCCH DMRS symbols, as shown in Step 3 of FIG. 10, to obtain ix_{c}. Through this accumulation operation, noise can be reduced, thereby improving the accuracy of cyclic shift and timing offset estimation.

In some embodiments, as illustrated in FIG. 9, the cyclic shift estimation block (930) may include a detection block (932) and an estimation block (934).

In some embodiments, the detection block (932) may detect a time index corresponding to the maximum value among the time domain samples of the CIR calculated by the CIR calculation block (920).

Some embodiments of the detection block (932) may correspond to Step 4 in FIG. 10.

For example, the detection block (932) may determine the time index k_{max,c} that has the maximum value among ix_{c}(n). This time index k_{max,c} may be expressed by Equations 8 and 9 for LTE SL and NR SL, respectively.

$${k}_{max , c}^{lte} ≅ - \frac{{N}^{′}}{N} ( ε - τ ) \qquad [ Equation 8 ]$$

$${k}_{max , c}^{nr} ≅ - \frac{4 {N}^{′}}{N} ( ε - τ ) \qquad [ Equation 9 ]$$

Meanwhile, in LTE SL, the linear phase and ε corresponding to n_{cs} can be expressed as:

$$exp ( \frac{j 2 π {n}_{c s} k}{12} ) = exp ( \frac{j 2 π ( ( {n}_{c s} / 3 ) \cdot ( N / 4 ) ) k}{N} )$$

and ε=(n_{cs}/3)·(N/4), where n_{cs}=0, 3, 6, or 9. By substituting these expressions into Equation 8, k_{max,c}^{lte} (i.e., k_{max,c} in LTE SL) can be derived and simplified as expressed in Equation 10.

$${k}_{max , c}^{lte} ≅ - ( {n}_{c s} / 3 ) \cdot {N}^{′} / 4 + \frac{{N}^{′}}{N} τ \qquad [ Equation 10 ]$$

In some embodiments, the estimation block (934) may estimate the cyclic shift corresponding to each of the at least one subchannel based on the time index detected by the detection block (932).

Some embodiments of the detection block (932) may correspond to Step 5 in FIG. 10.

For example, the estimation block (934) may estimate the cyclic shift based on the interval to which the time index with the maximum value of the channel impulse response (CIR) belongs among multiple intervals. In some embodiments, the multiple intervals may be obtained by partitioning the time domain interval of the channel impulse response based on the statistical characteristics of the channel impulse response when the cyclic shifts corresponding to the M subchannels are given. For example, the statistical characteristics of the channel impulse response may form sinc functions centered around each of the multiple intervals.

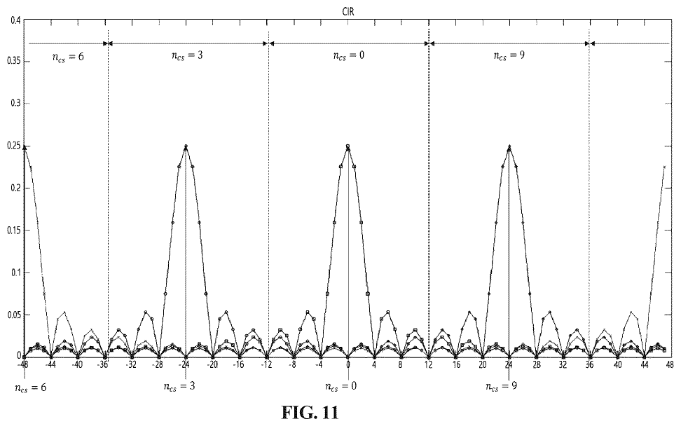

FIG. 11 illustrates an example of CIR in LTE SL when there is no timing offset.

More specifically, FIG. 11 shows the slice window for determining the cyclic shift of LTE SL based on k_{max,c}^{lte} when N_{PSCCH}^{RE}=24 and N′=96, along with the CIR for a timing offset of τ=0.

For instance, if −4≤k_{max,c}^{lte}<4 (i.e., the time index with the maximum value is between −4 and 4), the cyclic shift may be determined as n_{cs}=0 (i.e., the cyclic shift index corresponding to the slice window. in which k_{max,c} ^{lte} is located, as shown in FIG. 11). After determining the cyclic shift, the timing offset can be estimated based on the determined cyclic shift, as follows:

$$( {k}_{max , c}^{lte} + ( {n}_{c s} / 3 ) \cdot {N}^{′} / 4 ) \cdot \frac{N}{{N}^{′}}$$

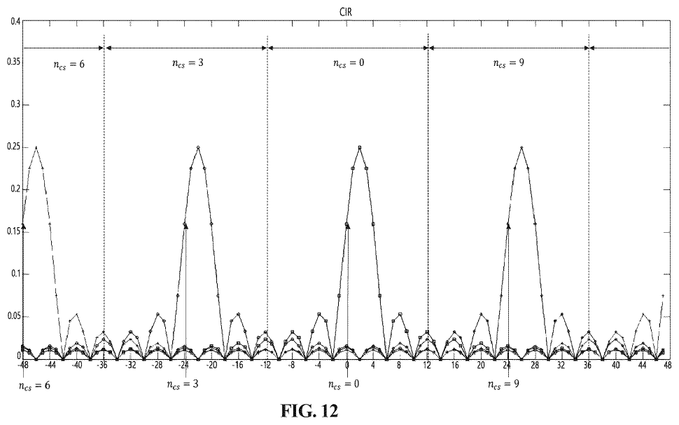

The SALG technique obtains CIR values at the center of slice windows, indicated by the black arrows in FIG. 11, and estimates the cyclic shift by comparing these CIR values. When there is no timing offset, as shown in FIG. 11, the performance of cyclic shift estimation may be at a level similar to some embodiments of the present disclosure since the CIR peak (i.e., the maximum value of the CIR) can be detected. However, the estimation performance of the SALG technique may significantly degrade in channel environments with timing offsets, multipath effects, and noise, as illustrated in FIG. 12.

FIG. 12 illustrates an example of CIR in LTE SL when a timing offset is present.

More specifically, unlike FIG. 11, FIG. 12 shows the CIR and slice windows when there is a timing offset

$$( timing offset \frac{{N}^{′}}{N} τ = 2 ) .$$

Referring to FIG. 12, the CIR values at the center of the slice windows do not have the maximum value due to the timing offset, which may lead to performance degradation in the SALG technique.

In NR SL, the DMRS RE index k′ exists at one RE for every 4 REs. Accordingly, the linear phase according to i is expressed as:

$$exp ( \frac{j 2 π i {k}^{′}}{3} ) = exp ( \frac{j 2 π i \cdot ( N / 3 ) \cdot {k}^{′} )}{N} ) = exp ( \frac{j 2 π i \cdot ( N / 3 ) \cdot ⌊ k / 4 ⌋ )}{N} )$$

where ε is given by:

$$ε = i \cdot ( \frac{N}{12} ) .$$

By substituting these values into Equation 9, k_{max,c}^{nr} (i.e., k_{max,c} in NR SL) can be expressed as Equation 11.

$${k}_{max , c}^{n r} ≅ - i \cdot {N}^{′} / 3 + \frac{4 {N}^{′}}{N} τ \qquad [ Equation 11 ]$$

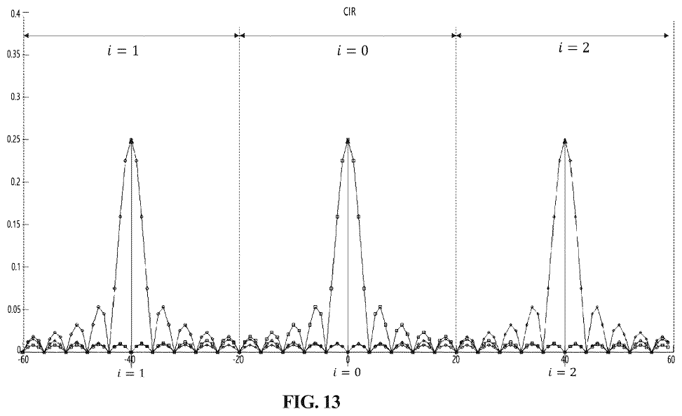

FIG. 13 illustrates an example of CIR when there is no timing offset in NR SL.

More specifically, FIG. 13 shows the slice window for determining the cyclic shift of NR SL based on k_{max,c}^{NR} when N_{PSCCH}^{RB}=10 and N_{PSCCH}^{RE}=N′=120, along with the CIR for a timing offset of τ=0.

For instance, if −20≤k_{max,c}^{nr}<20 (i.e., the time index with the maximum value is between −20 and 20), the cyclic shift may be determined as i=0 (i.e., the cyclic shift index corresponding to the slice window in which k_{max,c}^{nr} is located, as shown in FIG. 13). After determining the cyclic shift, the timing offset can be estimated based on the determined cyclic shift, as follows:

$$( {k}_{max , c}^{n r} + i \cdot {N}^{′} / 3 ) \cdot \frac{N}{4 {N}^{′}}$$

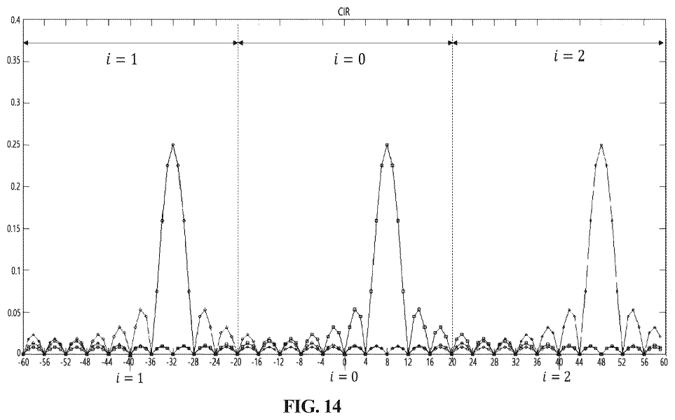

Meanwhile, similar to the explanation of FIG. 11, the SALG technique obtains CIR values at the center of slice windows, indicated by the black arrows in FIG. 13, and estimates the cyclic shift by comparing these CIR values. When there is no timing offset, as shown in FIG. 13, the performance of cyclic shift estimation may be at a level similar to some embodiments of the present disclosure since the CIR peak (i.e., the maximum value of the CIR) can be detected. However, the estimation performance of the SALG technique may significantly degrade in channel environments with timing offsets, multipath effects, and noise, as illustrated in FIG. 14.

FIG. 14 illustrates an example of CIR in NR SL when there is a timing offset.

More specifically, unlike FIG. 13, FIG. 14 shows the CIR and slice windows when there is a timing offset

$$( \frac{4 {N}^{′}}{N} τ = 8 ) .$$

Referring to FIG. 14, the CIR values at the center of the slice windows do not have the maximum value due to the timing offset, which may lead to performance degradation in the SALG technique. Furthermore, in LTE SL, the cyclic shift is given by: ε=(n_{cs}/3)·(N/4), where n_{cs}=0, 3, 6, or 9, resulting in CIR peak intervals of N/4. In contrast, in NR SL, the cyclic shift is expressed as: ε=i·(N/12), where i=0, 1, or 2, resulting in CIR peak intervals of N/12. As a result, in NR SL, there is a relatively higher probability that the timing offset may cause the peak to fall outside the main lobe, leading to an increased likelihood of incorrect cyclic shift estimation.

In some embodiments, a timing offset estimation block (940) may estimate the timing offset based on the channel impulse response estimated by the cyclic shift estimation block (930).

In some embodiments, the timing offset estimation block (940) may estimate the timing offset based on: the ratio between the size of the DFT (N) used in the DFT block (914) to generate at least one received reference signal group and the size of the IDFT (N′) used in the IDFT block (926) to calculate the channel impulse response; the time index (k_{max,c}) having the maximum value detected by the detection block (932); and the cyclic shift estimated by the estimation block (934) (e.g., n_{cs} for LTE SL or i for NR SL).

For example, in the case of LTE SL, the timing offset estimation block (940) may calculate the timing offset as:

$$( {k}_{max , c}^{lte} + ( {n}_{c s} / 3 ) \cdot {N}^{′} / 4 ) \cdot \frac{N}{{N}^{′}}$$

In another example, for NR SL, the timing offset estimation block (940) may calculate the timing offset as:

$$( {k}_{max , c}^{n r} + i \cdot {N}^{′} / 3 ) \cdot \frac{N}{4 {N}^{′}}$$

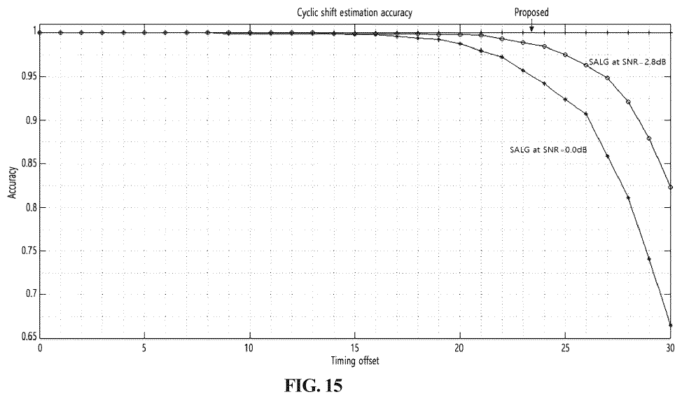

FIG. 15 illustrates a graph showing the performance of the cyclic shift estimation technique disclosed herein for LTE SL. More specifically, FIG. 15 compares the cyclic shift estimation performance of the disclosed technique with the SALG technique.

The simulation environment utilizes PSSCH requirement test number 4, as defined in Section 14.2 of the 3GPP standard document TS 36.101.

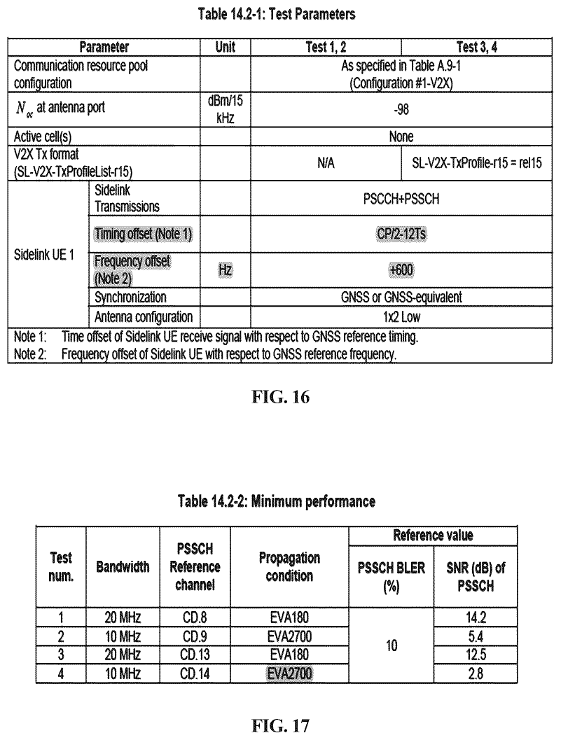

FIG. 16 shows Table 14.2-1 from the 3GPP standard document (3GPP 36.101), specifying performance requirements related to timing offset and frequency offset in LTE SL.

FIG. 17 shows Table 14.2-2 from the 3GPP standard document (3GPP 36.101), specifying performance requirements in LTE SL.

In the simulation environment, the frequency offset was set to 600 Hz, and the channel condition was configured as EVA2700, where the timing offset was varied from 0 to 30Tₛ. The cyclic shift estimation performance of the disclosed technique and the SALG technique were compared under these conditions. Additionally, simulations were conducted with SNR values of 2.8 dB, as defined in the standard document, and 0.0 dB for further evaluation.

Referring to FIG. 15, it can be observed that both techniques accurately estimate the cyclic shift when the timing offset is small. However, at the timing offset specified in the performance requirement (CP/2−12Tₛ=24Tₛ), the SALG technique exhibits estimation errors with accuracies of 0.941 and 0.983 at SNR values of 0 dB and 2.8 dB, respectively, as shown in FIG. 15.

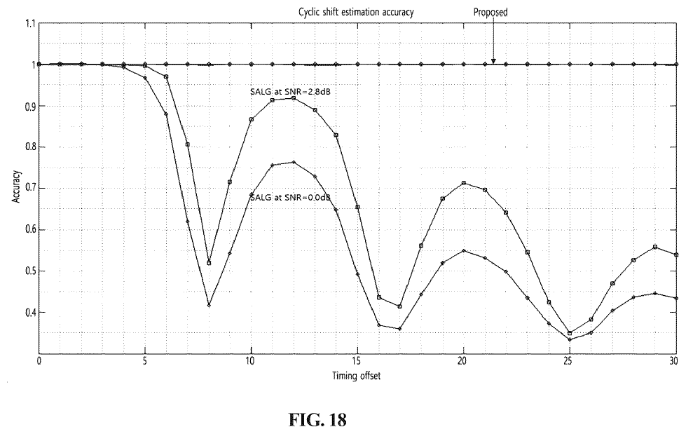

FIG. 18 illustrates a graph showing the performance of the cyclic shift estimation technique disclosed herein for NR SL. More specifically, FIG. 18 compares the cyclic shift estimation performance of the disclosed technique with the SALG technique.

The simulation environment utilizes PSSCH requirement test num. 1, as defined in Section 11.1.3 of the 3GPP standard document TS 38.101-4.

FIG. 19 illustrates performance requirements for NR SL.

In the simulation, the frequency offset was set to 600 Hz, and the channel condition was configured as TDLA30-1400, where the timing offset was varied from 0 to 30Tₛ. The cyclic shift estimation performance of the disclosed technique and the SALG technique were compared. Additionally, simulations were conducted with SNR values of 4.7 dB, as defined in the standard document, and 0.0 dB for further evaluation.

Referring to FIG. 18, it can be observed that both techniques accurately estimate the cyclic shift when the timing offset is small. However, at the timing offset specified in the performance requirement (CP/2−12Tₛ=24Tₛ), the SALG technique exhibits a rapid increase in estimation errors, with accuracies of 0.421 and 0.372 at SNR values of 0 dB and 4.7 dB, respectively, as shown in FIG. 18.

Furthermore, as mentioned earlier, the SALG technique experiences performance fluctuations due to the peak falling outside the main lobe, which can be confirmed in FIG. 18. In contrast, the disclosed technique maintains a minimum accuracy of 0.996, demonstrating the ability to achieve precise estimation even with large timing offsets, as shown in FIG. 18.

The aforementioned apparatus may be implemented using hardware components, software components, and/or a combination of hardware and software components. For example, the apparatus and components described in the embodiments may be implemented using one or more general-purpose or special-purpose computers, such as a processor, controller, arithmetic logic unit (ALU), digital signal processor, microcomputer, field-programmable gate array (FPGA), programmable logic unit (PLU), microprocessor, or any other device capable of executing and responding to instructions. The processing device may execute an operating system (OS) and one or more software applications running on the OS. Additionally, the processing device may access, store, manipulate, process, and generate data in response to the execution of software. For ease of understanding, a single processing device is described, but those skilled in the art will recognize that the processing device may include multiple processing elements and/or multiple types of processing elements. For example, the processing device may include multiple processors or a combination of a processor and a controller. Furthermore, other processing configurations, such as parallel processors, are also possible.

The software may include computer programs, codes, instructions, or any combination thereof, which configure the processing device to operate as desired or collectively command the processing device. The software and/or data may be embodied in any type of machine, component, physical device, computer storage medium, or device to be interpreted by the processing device or provide instructions or data to the processing device. The software may also be distributed across network-connected computer systems and stored or executed in a distributed manner. The software and data may be stored on one or more computer-readable recording media.

The methods according to the embodiments may be implemented in the form of program instructions that can be executed through various computer means and may be recorded on a computer-readable medium. In this case, the medium may continuously store the program executable by a computer or temporarily store it for execution or download. Moreover, the medium may include various recording or storage means formed by combining single or multiple hardware components, and it may not be limited to media directly connected to a computer system but also include media distributed across a network. Examples of media include magnetic media such as hard disks, floppy disks, and magnetic tapes, optical recording media such as CD-ROMs and DVDs, magneto-optical media such as floptical disks, and semiconductor memories such as ROM, RAM, and flash memory configured to store program instructions. Other examples of media may include recording or storage media managed by app stores or other software distribution sites or servers that distribute applications.

While the embodiments have been described above with reference to specific examples and drawings, those skilled in the art will appreciate that various modifications and variations are possible based on the above disclosure. For instance, the described technologies may be performed in a different order than described, and/or the components of the described systems, structures, devices, and circuits may be combined or arranged in different forms or replaced by other components or equivalents to achieve the desired results.

Accordingly, other implementations, embodiments, and equivalents thereof are within the scope of the appended claims.

What is claimed is:

1. A method of operating a receiver in a communication system where at least one OFDM symbol is transmitted, wherein a reference signal group of first to M-th subchannels (where M is a natural number greater than or equal to 2) are transmitted by at least one of the at least one OFDM symbol, and the reference signal group includes a plurality of reference signals to which cyclic shifts corresponding to a respective subchannel are applied, the method comprising:
generating, based on a received signal, at least one received reference signal group corresponding to the first subchannel, wherein each of the at least one received reference signal group includes received reference signals received through the corresponding OFDM symbol and the first subchannel;
calculating a channel impulse response of the first subchannel based on the at least one received reference signal group corresponding to the first subchannel; and
estimating a cyclic shift corresponding to the first subchannel based on the calculated channel impulse response of the first subchannel.

2. The method of claim 1, wherein generating the at least one received reference signal group comprises:
extracting at least one sample group corresponding to a symbol body of each of the at least one OFDM symbol from the received signal;
generating at least one frequency domain signal by applying Discrete Fourier Transform (DFT) to each of the extracted at least one sample group; and
extracting the received reference signals included in each of the at least one received reference signal group corresponding to the first subchannel from the generated at least one frequency domain signal.

3. The method of claim 1, wherein calculating the channel impulse response comprises:
generating a time domain signal corresponding to each of the at least one received reference signal group; and
calculating the channel impulse response based on the generated at least one time domain signal.

4. The method of claim 3, wherein generating the at least one time domain signal comprises:
generating at least one descrambling result symbol group by applying descrambling to each of the at least one received reference signal group; and
generating the at least one time domain signal by applying Inverse Discrete Fourier Transform (IDFT) to each of the generated at least one descrambling result symbol group.

5. The method of claim 4, wherein the size of the IDFT is four times the size of the descrambling result symbol group that is the target of IDFT.

6. The method of claim 4,
wherein the size of the IDFT is greater than or equal to the size of the descrambling result symbol group that is the target of IDFT, and
wherein applying the IDFT comprises applying the IDFT by positioning the center of the descrambling result symbol group that is the target of IDFT at the center of the IDFT window.

7. The method of claim 3,
wherein the reference signal group of the first subchannel is transmitted through one OFDM symbol,
wherein generating the at least one received reference signal group comprises generating one received reference signal group corresponding to the first subchannel,
wherein generating the at least one time domain signal comprises generating a time domain signal corresponding to the generated one received reference signal group, and
wherein calculating the channel impulse response comprises determining the generated one time domain signal as the channel impulse response.

8. The method of claim 3,
wherein the reference signal group of the first subchannel is transmitted through a plurality of OFDM symbols,
wherein generating the at least one received reference signal group comprises generating a plurality of received reference signal groups corresponding to the first subchannel,
wherein generating the at least one time domain signal comprises generating a time domain signal corresponding to each of the plurality of received reference signal groups, and
wherein calculating the channel impulse response comprises calculating the channel impulse response by summing time domain samples included in each of the generated time domain signals by the same time index.

9. The method of claim 1, wherein estimating the cyclic shift comprises:
detecting a time index having a maximum value among time domain samples of the channel impulse response; and
estimating the cyclic shift corresponding to each of the at least one subchannel based on the detected time index.

10. The method of claim 9,
wherein estimating the cyclic shift comprises estimating the cyclic shift based on an interval to which the time index having the maximum value of the channel impulse response belongs among a plurality of intervals, and
wherein the plurality of intervals are intervals obtained by dividing a time domain interval of the channel impulse response based on statistical characteristics of the channel impulse response when cyclic shifts corresponding to each of the M subchannels are given.

11. The method of claim 10, wherein the statistical characteristics of the channel impulse response form a sinc function centered on each of the plurality of intervals.

12. The method of claim 1, further comprising:
estimating a timing offset based on the estimated channel impulse response.

13. The method of claim 12,
wherein estimating the cyclic shift comprises estimating the cyclic shift corresponding to each of the at least one subchannel based on the time index having the maximum value among time domain samples of the channel impulse response, and
wherein estimating the timing offset comprises estimating the timing offset based on: a ratio between the size of DFT used in generating the at least one received reference signal group and the size of IDFT used in calculating the channel impulse response; the time index having the maximum value; and the estimated cyclic shift.

14. The method of claim 1, further comprising for each m (where m has a value between 2 and M):
generating, based on the received signal, at least one received reference signal group corresponding to the m-th subchannel, wherein each of at least one received reference signal group corresponding to the m-th subchannel includes received reference signals received through the corresponding OFDM symbol and the m-th subchannel;
calculating a channel impulse response of the m-th subchannel based on the at least one received reference signal group corresponding to the m-th subchannel; and
estimating a cyclic shift corresponding to the m-th subchannel based on the calculated channel impulse response of the m-th subchannel.

15. The method of claim 1,
wherein each of the first to M-th subchannels includes PSCCH and PSSCH of LTE sidelink, and
wherein the reference signal group of each of the first to M-th subchannels includes a reference signal group of the PSCCH included in the corresponding subchannel.

16. The method of claim 1,
wherein each of the first to M-th subchannels includes PSCCH and PSSCH of NR sidelink, and
wherein the reference signal group of each of the first to Mth subchannels includes a reference signal group of the PSCCH included in the corresponding subchannel.

17. A receiving apparatus in a communication system where where at least one OFDM symbol is transmitted, wherein a reference signal group of first to M-th subchannels (where M is a natural number greater than or equal to 2) are transmitted by at least one of the at least one OFDM symbol, and the reference signal group includes a plurality of reference signals to which cyclic shifts corresponding to a respective subchannel are applied, the apparatus comprising:
a received reference signal group generation block configured to generate, based on a received signal, at least one received reference signal group corresponding to the first subchannel, wherein each of the at least one received reference signal group includes received reference signals received through the corresponding OFDM symbol and the first subchannel;
a channel impulse response calculation block configured to calculate a channel impulse response of the first subchannel based on the at least one received reference signal group corresponding to the first subchannel; and
a cyclic shift estimation block configured to estimate a cyclic shift corresponding to the first subchannel based on the calculated channel impulse response of the first subchannel.

18. The apparatus of claim 17, wherein the received reference signal group generation block comprises:
a sample group extraction block configured to extract at least one sample group corresponding to a symbol body of each of the at least one OFDM symbol from the received signal;
a DFT block configured to generate at least one frequency domain signal by applying DFT to each of the extracted at least one sample group; and
a received reference signal extraction block configured to extract the received reference signals included in each of the at least one received reference signal group corresponding to the first subchannel from the generated at least one frequency domain signal.

19. The apparatus of claim 17, wherein the channel impulse response calculation block comprises:
a time domain signal generation block configured to generate a time domain signal corresponding to each of the at least one received reference signal group; and
a calculation block configured to calculate the channel impulse response based on the generated at least one time domain signal.

20. The apparatus of claim 19, wherein the time domain signal generation block comprises:
a descrambling block configured to generate at least one descrambling result symbol group by applying descrambling to each of the at least one received reference signal group; and
an IDFT block configured to generate the at least one time domain signal by applying IDFT to each of the generated at least one descrambling result symbol group.

21. The apparatus of claim 17, wherein the cyclic shift estimation block comprises:
a detection block configured to detect a time index having a maximum value among time domain samples of the channel impulse response; and
an estimation block configured to estimate the cyclic shift corresponding to each of the at least one subchannel based on the detected time index.

22. The apparatus of claim 17, further comprising:
a timing offset estimation block configured to estimate a timing offset based on the estimated channel impulse response.

23. The apparatus of claim 17, wherein for each m (where m has a value between 2 and M):
the received reference signal group generation block is configured to generate, based on the received signal, at least one received reference signal group corresponding to the m-th subchannel, wherein each of at least one received reference signal group corresponding to the m-th subchannel includes received reference signals received through the corresponding OFDM symbol and the m-th subchannel;
the channel impulse response calculation block is configured to calculate a channel impulse response of the m-th subchannel based on the at least one received reference signal group corresponding to the m-th subchannel; and
the cyclic shift estimation block is configured to estimate a cyclic shift corresponding to the m-th subchannel based on the calculated channel impulse response of the m-th subchannel.

24. The apparatus of claim 17,
wherein each of the first to M-th subchannels includes PSCCH and PSSCH of LTE sidelink, and
wherein the reference signal group of each of the first to M-th subchannels includes a reference signal group of the PSCCH included in the corresponding subchannel.

25. The apparatus of claim 17,
wherein each of the first to M-th subchannels includes PSCCH and PSSCH of NR sidelink, and
wherein the reference signal group of each of the first to Mth subchannels includes a reference signal group of the PSCCH included in the corresponding subchannel.
